(19) United States
(12) Patent Application Publication
(10) Pub. No.: US 2009/0255081 A1
(43) Pub. Date: Oct. 15, 2009

(54) Windshield Wiper Device

(75) Inventors: Mario Huesges, Buehlertal (DE); Detlef Lauk, Renchen (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/307,149

(22) PCT Filed: Nov. 30, 2007
(86) PCT No.: PCT/EP2007/063037

§ 371 Date: Dec. 31, 2008

(30) Foreign Application Priority Data
Dec. 29, 2006 (DE) 10 2006 061 957.9

(51) Int. Cl. B60S 1/06

(52) U.S. Cl. 15/250.31

(57) ABSTRACT

The invention relates to a window wiper device (1) for motor vehicles, in particular for rear windscreen wipers with a wiper motor which is inserted into a housing base body (20), and a pole housing (10). The pole housing (10) is embodied free of seams over a portion of the circumference.

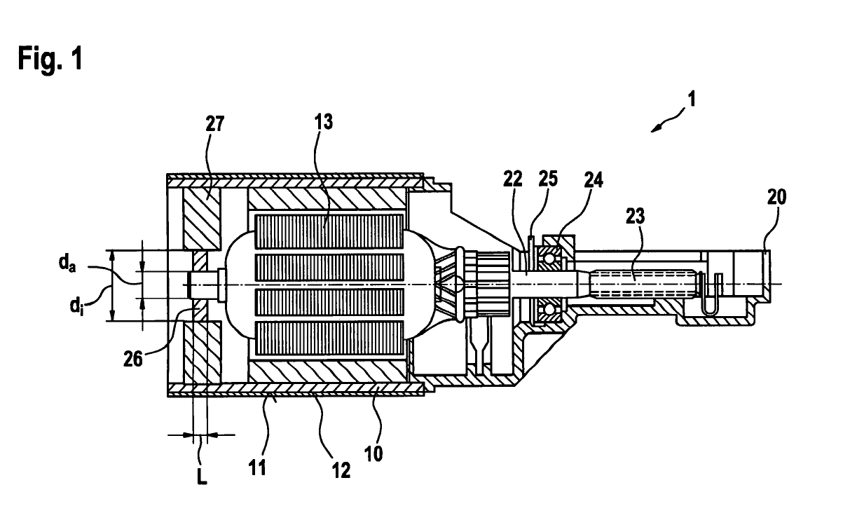

### BACKGROUND AND SUMMARY OF THE INVENTION

The present invention relates to a windshield wiper device for motor vehicles, in particular for rear windshield wipers comprising a wiper motor which is inserted into a housing base body, and a pole housing in which an armature is rotatably mounted.

Such windshield wiper devices are, for example, known from U.S. Pat. No. 4,920,289, DE 32 20 131 A1, DE 32 35 622 A1, DE 41 16 100 A1 as well as DE 39 30 144 C2.

In these known windshield wiper devices, a spherical bearing made of a sintered metal is used for mounting the armature shaft in the pole housing, and which is fixed at the base in a recess in the pole housing by a spring washer. The spring washer is adapted to the bearing. Owing to the rotatability of the spherical cap, the running characteristics of the wiper motor are not disadvantageously affected even with a slightly oblique position of the armature.

A drawback with such a windshield wiper device is, however, the very complicated and thus costly mounting of the spherical bearing.

The document EP-A-485001 discloses a method in which a roller bearing of an electric motor is inserted into a recess in the housing and is held by a projection formed in the recess. The manufacture of this projection as well as the recess is also complicated and costly.

The object of the invention, therefore, is to provide a windshield wiper device, in particular for rear windshield wipers of a motor vehicle, which provides a manufacture and mounting of the armature shaft in the pole housing which is as simple as possible.

This object is achieved according to the invention in that the pole tube is configured integrally and seamlessly over the circumference.

In other words, the pole housing is not formed conventionally as in the prior art from rolled sheet steel or as a deep-drawn part but is produced from a standard material in one piece, which is widely available, and for example simply deflected.

The use of a one-piece enclosed tubular material is also to be preferred due to its high mechanical rigidity and improved oscillatory and acoustic properties. Moreover, different lengths of pole housings may be produced in a simple manner, in which the adjustment to the desired length to be cut off may be altered on the machine by a single input into the computer.

Due to the simplicity of the selected manufacturing material, it is associated with very little cost to provide the pole housing with anti-corrosive surfaces. Due to the simple manufacturing process and the only slight loading of the outer surface of the pole housing, the material loading as a result of treating the tubular cover does not have to be taken into account.

The pole housing may consist of steel, a ceramic material or sintered metal.

One advantageous embodiment of the invention accordingly provides to form the pole housing from a tubular portion deflected from a process endless tube produced in a continuous process. This tubular portion may be produced from widely available raw material, such as for example a steel tube, which as a steel material is cut to length.

In an alternative embodiment, the pole housing is formed by a bushing produced by gravity die casting.

For fastening to the bearing arrangement of the armature shaft arranged in the pole housing, a mounting element may be fastened to the pole housing. An opening, for example, may be provided in the mounting element which serves as a bearing.

The diameter of the opening in the mounting element may be adapted to the dimensions of the bearing arrangement of the armature shaft depending on the application, so that each cylindrical bearing may be inserted into the mounting element irrespective of the external diameter thereof and thus may be used in the pole housing. This allows a particularly flexible assembly according to the type of loading and strength of the armature shaft.

The mounting element may be either positioned or screwed on the pole housing in the form of a cap or inserted into the pole housing and fixed therein. This may, for example, be achieved by forming an interference fit between the pole housing and the mounting element.

By the choice of the individual components, the mounting may be selected to be very flexible in particular the sequence of the mounting. With regard to further advantageous embodiments and developments of the invention, reference is made to the sub-claims and the following description of the drawings.

### BRIEF DESCRIPTION OF THE DRAWING

### DETAILED DESCRIPTION

An electrical drive unit shown in the figure of a windshield wiper device for motor vehicles according to the invention comprises a substantially cup-shaped pole housing 10 which is integrally and seamlessly configured over the circumference. The pole housing 10 is formed from a tubular portion deflected from an endless tube produced in a continuous process and is provided at its outer surface 11 with an anti-corrosive layer 12. An electrical armature 13 known per se is inserted in the pole housing 10. At the front face, on the pole housing 10 a similarly substantially cup-shaped gear housing 20 is fastened, in which a transmission gear wheel 21 is received, which engages in a worm 23 connected to an armature shaft 22 of the armature 2. The armature shaft 22 is mounted in the gear housing 20 in a spherical bearing 24, which is axially secured by a retaining clip 25 in the gear housing 20.

The armature shaft 22 on its side remote from the gear housing 20 is mounted in the pole housing 10 by means of a cylindrical bearing 26 mounted by an interference fit. The cylindrical bearing 26 consists of a sintered metal. The toroidal and/or annular body of the cylindrical bearing 26 forms a lubricant storage.

As a result of the large external diameter of the cylindrical bearing 26 which is substantially greater than a length L, when mounting the cylindrical bearing 26 by an interference fit, the internal diameter dᵢ corresponding to the external diameter of the armature shaft 22 is prevented from being reduced in diameter. Moreover, the mounting of the armature shaft 22 is thereby simplified.

The large external diameter dₐ of the pressed-in cylindrical bearing 26, also allows in particular a sufficient pole volume for the lubricant and thus ensures efficient lubrication of the cylindrical bearing 26 over a long period. Due to the shorter length L of the cylindrical bearing 26, the possible oblique positions of the armature shaft 22 do not act disadvantageously on the running of the drive unit, as due to the shortness of the cylindrical bearing 26 in practice it may not lead to distortion of the armature shaft 22 in the cylindrical bearing 26.

Additional securing elements, not shown, may be provided for fixing the cylindrical bearing 26 in its position within the pole housing 1, such as for example spring washers or clamping rings.

The cylindrical bearing 26 may be clamped in a mounting element 27 which is also of cylindrical configuration in order to be able to design the external diameter of the cylindrical bearing 26 to be variable and thus also to be able to adapt the lubricating properties to the respective conditions of use and thus to keep material costs as low as possible. Each cylindrical bearing 26 may be inserted via the mounting element 27 irrespective of the external diameter dₐ thereof. Additionally, the mounting element 27 may either be positioned or screwed as a type of cap onto the pole housing 10 or inserted into the pole housing 10 and fixed therein, for example by forming an interference fit between the pole housing 10 and the mounting element 27. The mounting element 27 may be fastened to the cylindrical bearing 26 preassembled on the pole housing. It is, however, also possible to preassemble the cylindrical bearing 26 initially on the armature shaft 22, and subsequently to insert into the mounting element 27, or even directly mount each individual component.

1. A windshield wiper device (1) for motor vehicles, comprising a wiper motor which is inserted into a housing base body (20) and a pole housing (10), characterized in that the pole housing (10) is configured integrally and seamlessly over the circumference.

2. The windshield wiper device (1) as claimed in claim 1, characterized in that the pole housing (10) is formed from a tubular portion cut to length from an endless tube produced in a continuous process.

3. The windshield wiper device (1) as claimed in claim 1, characterized in that a peripheral surface (11) of the pole housing (10) is provided with an anti-corrosive layer (12).

4. The windshield wiper device (1) as claimed in claim 1, characterized in that the pole housing (10) is produced from steel, sintered metal or ceramics.

5. The windshield wiper device (1) as claimed in claim 1, characterized in that the pole housing (10) is formed by a bushing produced by gravity die casting.

6. The windshield wiper device (1) as claimed in claim 1, characterized in that for fastening a bearing arrangement of the armature shaft (22) arranged in the pole housing (10), a mounting element (27) may be fastened to the pole housing (10).

7. The windshield wiper device (1) as claimed in claim 6, characterized in that in the mounting element (27) an opening is provided which serves as a bearing seat, and the diameter thereof is able to be adapted to the dimensions of the bearing arrangement of the armature shaft (22).

8. The windshield wiper device (1) as claimed in claim 6, characterized in that the mounting element (27) may be mounted by an interference fit on the pole housing (10).

9. The windshield wiper device (1) as claimed in claim 6, characterized in that the mounting element (27) may be fixed by means of securing elements, in particular spring washers, in its position on the pole housing (10).

10. The windshield wiper device (1) as claimed in claim 6, characterized in that the mounting element (27) may be pushed and/or screwed onto the pole housing (10).

11. The windshield wiper device (1) as claimed in claim 6, characterized in that in the mounting element (27) an opening is provided which serves as a bearing seat, and the diameter thereof is able to be adapted to the dimensions of a cylindrical bearing (26).

12. The windshield wiper device (1) as claimed in claim 2, characterized in that a peripheral surface (11) of the pole housing (10) is provided with an anti-corrosive layer (12).

13. The windshield wiper device (1) as claimed in claim 12, characterized in that the pole housing (10) is produced from steel, sintered metal or ceramics.

14. The windshield wiper device (1) as claimed in claim 1, characterized in that the pole housing (10) is formed by a bushing produced by gravity die casting.

15. The windshield wiper device (1) as claimed in claim 14, characterized in that for fastening a bearing arrangement of the armature shaft (22) arranged in the pole housing (10), a mounting element (27) may be fastened to the pole housing (10).

16. The windshield wiper device (1) as claimed in claim 14, characterized in that in the mounting element (27) an opening is provided which serves as a bearing seat, and the diameter thereof is able to be adapted to the dimensions of the bearing arrangement of the armature shaft (22), in particular of a cylindrical bearing (26).

17. The windshield wiper device (1) as claimed in claim 16, characterized in that the mounting element (27) may be mounted by an interference fit on the pole housing (10).

18. The windshield wiper device (1) as claimed in claim 17, characterized in that the mounting element (27) may be fixed by means of securing elements, in particular spring washers, in its position on the pole housing (10).

19. The windshield wiper device (1) as claimed in claim 17, characterized in that the mounting element (27) may be pushed and/or screwed onto the pole housing (10).
